(19) United States
(12) Patent Application Publication
(10) Pub. No.: US 2024/0286000 A1
(43) Pub. Date: Aug. 29, 2024

(54) SPINNING BIKE WITH DOUBLE-FLYWHEEL STRUCTURE

(71) Applicant: Zhejiang Feier Intelligent Technology Co., Ltd., Hangzhou (CN)

(72) Inventors: Longfei Wang, Dingzhou City (CN); Shuai Wang, Dingzhou City (CN)

(21) Appl. No.: 18/334,671

(22) Filed: Jun. 14, 2023

(30) Foreign Application Priority Data
Feb. 23, 2023 (CN) 202320348107.X

(51) Int. Cl. A63B 22/06; A63B 21/22

(52) U.S. Cl. CPC A63B 22/0605; A63B 21/225; A63B 2022/0658

(57) ABSTRACT

The present utility model provides a spinning bike with a double-flywheel structure, which comprises a frame, wherein two concentric and synchronous rotating flywheels are arranged in a middle position of the frame, a transmission disc is arranged on the frame and drives the two flywheels to synchronously rotate through a transmission member, and a damping magnetic resistance is arranged on the frame between the transmission disc and the flywheels. According to the present utility model, a single flywheel is replaced with a parallel double-flywheel structure without reducing flywheel weight, so as to lower a center of gravity of an entire spinning bike and improve the stability of product, and the diameter of the flywheel is smaller than that of the conventional flywheel, which can have the effect of more timely braking feedback and increased safety. In addition, the double-flywheel parallel structure is used to achieve extreme compression in the product space, which meets the needs of mini fitness equipment at home and space-saving; and the double-flywheel spinning bike achieves the double-flywheel double-magnetic control technology by increasing the number of the flywheels and damping magnetic resistances without increasing occupied space, thus improving fat burning efficiency.

### TECHNICAL FIELD

The present utility model relates to the technical field of fitness equipment, and in particular to a spinning bike with a double-flywheel structure.

### BACKGROUND

After technical improvements, a spinning bike overcomes the defect of outdoor driving and becomes an aerobic exercise that can exercise the whole body. The spinning exercise can enhance the strength of the legs, beautify the shape of the lower limbs, increase the body's oxygen intake, and consume a lot of energy. According to data, effective 40-minute spinning training can consume about 500 kcal. of heat. However, with the increasing market share of the spinning bike, pain points of existing products in the current market are gradually clear, that is, the conventional single-flywheel spinning bike is easy to shake, not stable enough, and easy to have accidents; secondly, a product that corresponds to the existing product meeting a cycling resistance range has a larger size, and a spinning bike that occupies a small space cannot meet the demand for fat burning. This structure is a combination of a single flywheel, a single belt pulley, and a single damping magnetic resistance, which results in the problem that the product's action form is limited, and the exercise intensity and the occupied space cannot meet the needs at the same time.

### SUMMARY

The present utility model provides a spinning bike with a double-flywheel structure, so as to solve the problem that the existing spinning bike with a single flywheel structure proposed in the above background is easy to shake, and the product that meets the cycling resistance is too large in size, and the product that occupies a small space cannot meet the demand for fat burning.

The technical solution of the present utility model is implemented in that:

A spinning bike with a double-flywheel structure, comprising: a frame, wherein two concentric and synchronous rotating flywheels are arranged in a middle position of the frame, a transmission disc is arranged on the frame, the transmission disc drives the two flywheels to synchronously rotate through a transmission member, a damping magnetic resistance is arranged on the frame between the transmission disc and the flywheels, and two damping magnetic resistances are provided and are in a one-to-one correspondence with the two flywheels.

Preferably, centers of the two flywheels are connected through a flywheel bottom bracket, and the transmission member is connected to the flywheel bottom bracket.

Preferably, a hub spindle is in synchronous rotary connection to a middle position of the transmission disc, a crank is connected to a hub spindle, and pedals are connected to tail ends of the crank.

Preferably, a shell configured to protect the transmission disc and the flywheel is installed on the frame, and a front cover is detachably installed in front of the shell; a liftable armrest component is arranged at a front end of the shell, and a liftable seat cushion component is arranged at a rear end of the shell.

Preferably, an adjusting knob configured to control the damping magnetic resistance is arranged on the armrest component.

Preferably, the transmission member is a belt or a chain.

With the above technical solution, the present utility model has the following beneficial effects:
(1) The present utility model has a simple design structure and is convenient to use, wherein a single flywheel is replaced with a parallel double-flywheel structure without reducing flywheel weight, so as to lower a center of gravity of an entire spinning bike and improve the stability of product, and the diameter of the flywheel is smaller than that of the conventional flywheel, which can have the effect of more timely braking feedback and increased safety;
(2) According to the present utility model, the double-flywheel parallel structure is used to achieve extreme compression in the product space, which meets the needs of mini fitness equipment at home and space-saving; and the double-flywheel spinning bike achieves the double-flywheel double-magnetic control technology by increasing the number of the flywheels and damping magnetic resistances without increasing occupied space, thus improving fat burning efficiency;
(3) Compared with the conventional spinning bike, the double-flywheel spinning bike of the present utility model has a smaller diameter in the flywheel and more timely braking feedback; the ankle joint is effectively protected, and the safety is improved;
(4) The present utility model adopts a single transmission member to drive two flywheels, thereby reducing the production cost and facilitating the later maintenance; and
(5) The visualized flywheel of the present utility model makes the movement more intuitive during the cycling experience process of the user, and improves the interactivity and interest.

### BRIEF DESCRIPTION OF THE DRAWINGS

In order to more clearly illustrate the technical solution in the embodiments of the present utility model or in the prior art, the drawings required to be used in the description of the embodiments or the prior art are briefly introduced below. It is obvious that the drawings in the description below are only some embodiments of the present utility model, and those of ordinary skill in the art can obtain other drawings according to these drawings without creative efforts.

FIG. 1 is a perspective view of the present utility model;

FIG. 2 is a diagram of an installation structure of a flywheel and a transmission disc according to the present utility model; and

FIG. 3 is a schematic diagram of a damping magnetic resistance according to the present utility model.

### REFERENCE NUMERALS

1: frame; 2: shell; 3: front cover; 4: armrest lifting frame; 5: armrest; 6: adjusting knob; 7: seat cushion; 8: adjusting block; 9: seat cushion lifting frame; 10: flywheel; 11: flywheel bottom bracket; 12: transmission member; 13. damping magnetic resistance; 14: transmission disc; 15: hub spindle; 16: crank; 17: pedal; 18: electric motor; 19: cable; 20: limiting screw-rod; 21: connecting plate; and 22: steel wire rope.

### DETAILED DESCRIPTION OF THE EMBODIMENTS

The technical solution in the embodiments of the present utility model will be clearly and completely described below with reference to the drawings in the embodiments of the present utility model. It is apparent that the described embodiments are only some, but not all, embodiments of the present utility model. Based on the embodiments of the present utility model, all other embodiments obtained by those of ordinary skill in the art without creative efforts fall within the protection scope of the present utility model.

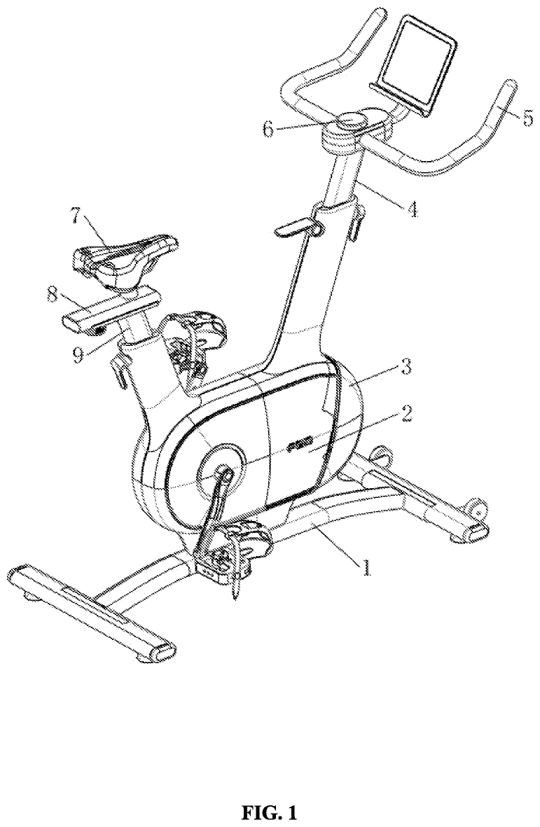

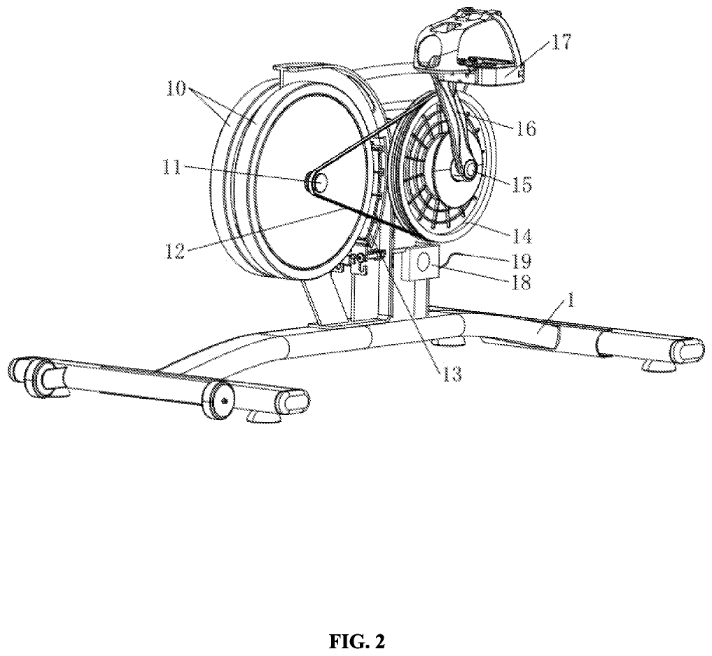

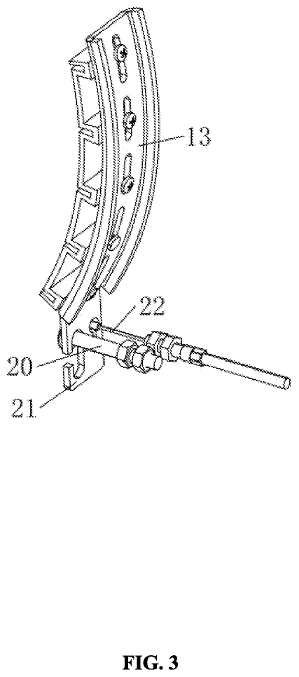

Referring to FIGS. 1-3, the spinning bike with the double-flywheel structure comprises a frame 1, wherein the frame 1 can be designed into an integrated structure or a split structure, two concentric and synchronous rotating flywheels 10 are arranged in a middle position of the frame 1, a transmission disc 14 is arranged on the frame 1, the transmission disc 14 drives the two flywheels 10 to synchronously rotate through a transmission member 12, a damping magnetic resistance 13 is arranged on the frame 1 between the transmission disc 14 and the flywheels 10, and two damping magnetic resistances 13 are provided and are in a one-to-one correspondence with the two flywheels 10, and compared with a conventional single damping structure, the double-damping magnetic resistance 13 can provide more resistance for the flywheels 10.

In this embodiment, the two flywheels 10 and the transmission disc 14 are arranged on left and right sides in the spinning bike, and a connecting line between the centers of the flywheels 10 and the transmission disc 14 is parallel to a horizontal plane, so that the transmission effect is more stable; in addition, the relative positions of the two flywheels 10 and the transmission plate 14 may also be an up-down arrangement, a front-rear arrangement, an inclined arrangement of the center connecting line, and the like. This is not limited herein.

Specifically, the centers of the two flywheels 10 are connected through a flywheel bottom bracket 11, the flywheel bottom bracket 11 is in synchronous rotary connection to the two flywheels 10 and can adopt an integrated structure or a key connection structure, the flywheel bottom bracket 11 is installed on the frame 1 through a bearing, and the transmission member 12 is connected to the flywheel bottom bracket 11, so that when the transmission member 12 rotates, the flywheel bottom bracket 11 can be driven to rotate, and then the two flywheels 10 are driven to rotate.

Specifically, a hub spindle 15 is in synchronous rotary connection to a middle position of the transmission disc 14, a crank 16 is connected to a hub spindle 15, and pedals 17 are connected to tail ends of the crank 16, wherein two cranks 16 are provided and arranged at two sides of the transmission disc 14.

Specifically, a shell 2 configured to protect the transmission disc 14 and the flywheel 10 is installed on the frame 1, a front cover 3 is detachably installed in front of the shell 2, and the front cover 3 is installed on the shell 2 by means of snaps or bolts, that is, the front cover 3 can be detached; and in the detached state, the two flywheels 10 are exposed, so as to achieve the visual effect of the flywheels 10. In this way, the movement can be made more intuitive during the cycling experience of users, and the interactivity and interest can be improved.

A liftable armrest 5 component is arranged at a front end of the shell 2, wherein the armrest 5 component comprises an armrest lifting frame 4 which is inserted into the shell 2 and can be lifted and adjusted, two sides above the armrest lifting frame 4 are connected to armrests 5, a display is arranged in a middle position above the armrest lifting frame 4 to monitor cycling data, a liftable seat cushion 7 component is arranged at a rear end of the shell 2, the seat cushion 7 component comprises a seat cushion lifting frame 9 which can be inserted into the shell 2 and has a height adjusting function, an adjusting block 8 is arranged above the seat cushion lifting frame 9, the adjusting block 8 can slide in front and rear directions of the spinning bike, when the seat cushion slides to a designated position, the adjusting block 8 and the seat cushion lifting frame 9 are fixed by using a threaded knob, and the seat cushion 7 is arranged above the adjusting block 8. Both the armrest 5 component and the seat cushion 7 component have a height adjusting function. When the height is adjusted in place, the armrest 5 component and the seat cushion 7 component can be locked by using a lock. The locking structure belongs to the conventional technology in the prior art, which will not be excessively described here. The seat cushion 7 also has the function of front and rear adjustment, so that the application range of people can be enlarged, and the application range is wider.

Specifically, the armrest 5 component is provided with an adjusting knob 6 configured to control a damping magnetic resistance 13, wherein the adjusting knob 6 is connected to an electric motor 18 positioned on the frame 1 by a cable 19, and the electric motor 19 can be controlled by the adjusting knob 6. An output shaft of the electric motor 19 is connected to a connecting plate 21 below the damping magnetic resistance 13 by a steel wire rope 22, that is, the tightness of the steel wire rope 22 can be controlled by the electric motor 19, so as to control the positions of the two damping magnetic resistances 13, thereby providing more resistance for the flywheel 10 under the action of the two damping magnetic resistances 13. In addition, a limiting screw-rod 20 is further installed on the connecting plate, and the other end of the limiting screw-rod 20 is fixed on the frame 1 by two nuts, so that the damping magnetic resistance 13 can be prevented from directly touching the flywheel 10 to affect the rotation of the flywheel 10.

Specifically, the transmission member 12 is a belt or a chain.

When the spinning bike is used, after the heights of the armrest 5 component and the seat cushion 7 component are adjusted, a user sits on the seat cushion 7, holds the armrests 5 with both hands, steps on the pedals 17 with both feet to perform cycling exercise. The damping of the flywheel 10 is adjusted by rotating the adjusting knob 6. Due to the adoption of the structure of the parallel double flywheels 10, the flywheels 10 have a small and compact size, lower gravity center, more stable cycling process, and better fat-burning efficiency.

The above mentioned contents are only preferred embodiments of the present utility model and are not intended to limit the present utility model. Any modification, equivalent substitution, improvement, etc., made within the spirit and principle of the present utility model shall all fall within the scope of protection of the present utility model.

1. A spinning bike with a double-flywheel structure, comprising: a frame (1), wherein two concentric and synchronous rotating flywheels (10) are arranged in a middle position of the frame (1), a transmission disc (14) is arranged on the frame (1), the transmission disc (14) drives the two flywheels (10) to synchronously rotate through a transmission member (12), and a damping magnetic resistance (13) is arranged on the frame (1) between the transmission disc (14) and the flywheels (10).

2. The spinning bike with the double-flywheel structure according to claim 1, wherein centers of the two flywheels (10) are connected through a flywheel bottom bracket (11), and the transmission member (12) is connected to the flywheel bottom bracket (11).

3. The spinning bike with the double-flywheel structure according to claim 1, wherein a hub spindle (15) is in synchronous rotary connection to a middle position of the transmission disc (14), a crank (16) is connected to a hub spindle (15), and pedals (17) are connected to tail ends of the crank (16).

4. The spinning bike with the double-flywheel structure according to claim 1, wherein a shell (2) configured to protect the transmission disc (14) and the flywheel (10) is installed on the frame (1), and a front cover (3) is detachably installed in front of the shell (2); a liftable armrest (5) component is arranged at a front end of the shell (2), and a liftable seat cushion (7) component is arranged at a rear end of the shell (2).

5. The spinning bike with the double-flywheel structure according to claim 2, wherein an adjusting knob (6) configured to control the damping magnetic resistance (13) is arranged on the armrest (5) component.

6. The spinning bike with the double-flywheel structure according to claim 1, wherein the transmission member (12) is a belt or a chain.

7. The spinning bike with the double-flywheel structure according to claim 1, wherein two damping magnetic resistances (13) are provided and are in a one-to-one correspondence with the two flywheels (10).
